(19) United States
(12) Patent Application Publication
(10) Pub. No.: US 2021/0237371 A1
(43) Pub. Date: Aug. 5, 2021

(54) METHOD FOR MANUFACTURING A PART MADE OF COMPOSITE MATERIAL COMPRISING AT LEAST ONE STEP OF DETECTING PIECES OF PROTECTIVE FILM

(71) Applicant: Airbus Operations SAS, TOULOUSE (FR)

(72) Inventors: Jean-Pascal CABOT, TOULOUSE (FR); Xavier KERN, TOULOUSE (FR)

(21) Appl. No.: 17/166,792

(22) Filed: Feb. 3, 2021

(30) Foreign Application Priority Data
Feb. 5, 2020 (FR) 2001116

(51) Int. Cl. B29C 70/30; B29C 70/54; B29C 70/88

(52) U.S. Cl. CPC B29C 70/30; B29C 70/88; B29C 70/54

(57) ABSTRACT

A method for manufacturing a part made of composite material, comprising at least one step of detecting any protective films or pieces of protective films via particles present in the protective film, before a polymerization step.

### CROSS-REFERENCES TO RELATED APPLICATIONS

This application claims the benefit of the French patent application No. 2001116 filed on Feb. 5, 2020, the entire disclosures of which are incorporated herein by way of reference.

### FIELD OF THE INVENTION

The present application relates to a method for manufacturing a part made of composite material, comprising a step of detecting pieces of protective film.

### BACKGROUND OF THE INVENTION

According to one embodiment, a part made of composite material is produced by stacking layers of pre-impregnated fibers on top of one another, then polymerizing them.

Each layer of pre-impregnated fibers comes from a fiber ply which comprises, in addition to the layer of pre-impregnated fibers, a protective film covering one of the faces of the layer of pre-impregnated fibers. According to one procedure, each fiber ply is cut from a strip packaged as a roll.

Since the presence of a protective film or of a piece of protective film in the part obtained after the polymerization step reduces its mechanical properties, it is important to detect this presence as early as possible, and in any event before the polymerization step.

According to one procedure, after the positioning of each layer of pre-impregnated fibers, a visual verification is carried out in order to ensure that no protective film or piece of protective film remains. This visual verification makes it possible to detect the largest pieces in order to remove them.

However, the cutting of the fiber plies can generate small pieces of protective film that are difficult to detect visually and that can affect the mechanical properties of the part made of composite material thus obtained. In order to overcome the presence of these possible small pieces of protective film that would not have been detected, layers of fibers are added. This solution is not satisfactory since it results in an increase in the mass and the cost of the part thus obtained.

The present invention aims to overcome all or some of the drawbacks of the prior art.

### SUMMARY OF THE INVENTION

To this end, a subject of the invention is a method for manufacturing a part made of composite material, the part made of composite material comprising a stack of layers of fibers from fiber plies, a fiber ply comprising at least one layer of fibers and also at least one protective film covering at least one of the faces of the layer of fibers and comprising at least one matrix of at least one material. The protective film comprises particles, embedded in the matrix of the protective film, having at least one physical characteristic different from those of the fibers of the layer of fibers, the physical characteristic being detectable by at least one suitable sensor and the particles being distributed uniformly over the entire area of the protective film.

The manufacturing method comprises a step of laying up layers of fibers from fiber plies, a step of removing a protective film for each fiber ply, and also a polymerization or consolidation step. A feature of the manufacturing method is that it comprises, before the polymerization or consolidation step, at least one step of detecting the particles of a protective film or piece of protective film possibly present on at least one laid-up layer of fibers.

This solution makes it possible to detect any small pieces of protective film that are present on the layers of fibers during the laying up of the layers and to avoid adding additional layers of fibers. Moreover, the presence of detectable particles allows the detection of small pieces of film, even in areas of complex shape. Finally, it makes it possible to gain time during the step of verifying the parts.

According to other features taken separately or in combination:
the manufacturing method comprises several detection steps during the laying up step, a detection step after each positioning of a layer of fibers;
the detection step comprises moving, above the final positioned layer of fibers, at least one sensor configured to detect at least one particle;
the sensor is a magnetic sensor or an inductive sensor;
this at least one magnetic sensor is moved so as to run over the entire area of the final positioned layer of fibers in order to detect a particle regardless of its position on the layer of fibers;
the particles are magnetic;
the particles exhibit permanent magnetization or are configured to become magnetic in the presence of a magnetic field;
the particles have a density such that a piece of protective film having an area of about 25 mm2, regardless of its position in the protective film, is detectable.

### BRIEF DESCRIPTION OF THE DRAWINGS

Other features and advantages will emerge from the description of the invention that will follow, the description being given by way of example only, with reference to the appended drawings, in which:

FIG. 1 is a section of a preform of layers of fibers illustrating a detection step of one embodiment of the invention, and

FIG. 2 is a section of a fiber ply exhibiting a protective film comprising magnetic particles.

### DETAILED DESCRIPTION OF THE PREFERRED EMBODIMENTS

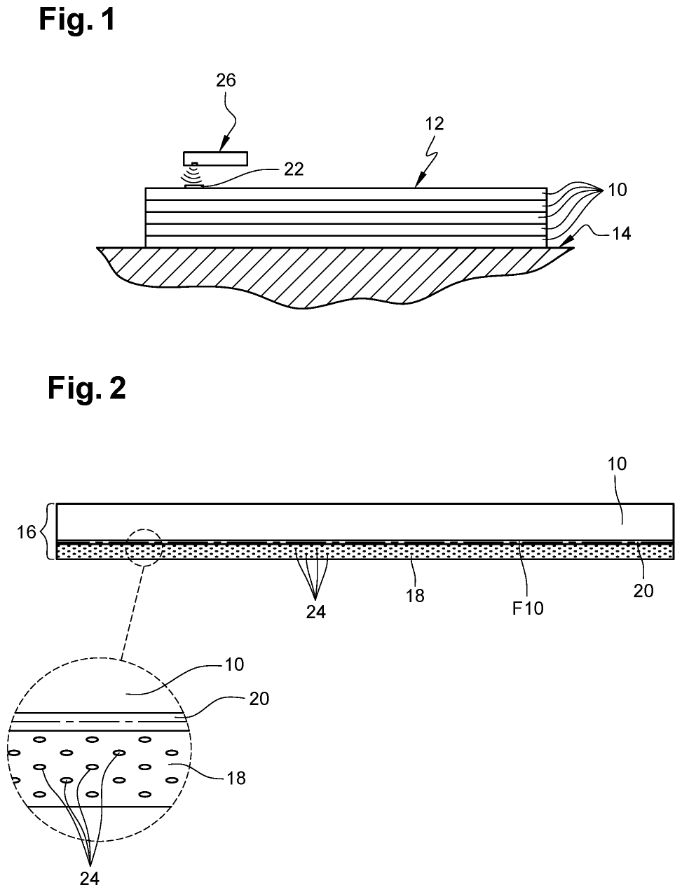

According to one embodiment that can be seen in FIG. 1, a method for manufacturing a part made of composite material comprises a step of laying up layers of fibers 10, comprising positioning the layers of fibers 10 on top of one another in order to obtain a preform of fibers 12, then a polymerization or consolidation step in order to stiffen the preform of fibers 12 and to obtain the part made of composite material.

The fibers of each layer of fibers 10 can be made of various materials, such as glass, carbon, aramid or the like. After the polymerization step, the fibers are embedded in a matrix of thermosetting or thermoplastic resin.

The fibers of each layer of fibers 10 may or may not be woven.

According to one procedure, the fibers are pre-impregnated with resin before the layers of fibers 10 are stacked. According to another procedure, the fibers of the layers of fibers 10 are dry during the laying up step and are pre-impregnated with resin after the laying up step, just before or concomitantly with the polymerization or consolidation step.

During the laying up step, the layers of fibers 10 are positioned manually or in an automated manner on a positioning surface 14. According to a first embodiment, the positioning surface 14 has a geometry identical to one of the faces of the part made of composite material to be produced. According to another embodiment, the positioning surface 14 is planar and the manufacturing method comprises a step of forming the preform of fibers 12 before the polymerization or consolidation step.

As illustrated in FIG. 2, each layer of fibers 10 comes from a fiber ply 16 which comprises at least one layer of fibers 10 and also at least one protective film 18 covering at least one of the faces F10 of the layer of fibers 10 and comprising at least one matrix of at least one material.

The fiber ply 16 can comprise other layers or films, such as a film of resin 20.

According to a first configuration, the fiber plies 16 are cut out beforehand and have dimensions in accordance with the part made of composite material to be produced.

According to another configuration, the method for producing a part made of composite material comprises, before the laying up step, a step of cutting the fiber plies 16 from fiber strips.

For each fiber ply 16, the manufacturing method comprises a step of removing the protective film 18. According to one procedure, this removal step is carried out once the fiber ply 16 has been positioned on the final positioned layer of fibers 10 of the preform 12. As a variant, the protective film 18 could be removed before the laying up step.

According to one embodiment, the matrix of the protective film 18 is made of polypropylene and the protective film 18 has a thickness of about ten or so micrometers to a few hundred micrometers.

Since the presence of protective film 18 or pieces of protective film 22 in the part made of composite material reduces its mechanical properties, the manufacturing method comprises at least one step of detecting a protective film 18 or a piece of protective film 22 possibly present on at least one laid-up layer of fibers 10, before the polymerization or consolidation step.

According to one embodiment, the manufacturing method comprises several detection steps during the laying up step, in particular, a detection step after each positioning of a layer of fibers 10. This embodiment makes it possible to detect any protective film 18 or piece of protective film 22 before it is covered with a layer of fibers 10.

According to one feature of the invention, the protective film 18 of each fiber ply 16 comprises a matrix of at least one material and magnetic particles 24 embedded in this matrix. Thus, the magnetic particles 24 are inserted in the protective film 18 and are not affixed on one of its faces, thereby limiting the risks of separation of the magnetic particles 24 from the protective film 18, by tearing off, for example.

These magnetic particles 24 are uniformly distributed over the entire area of the protective film 18 with a density such that an acceptable area of the protective film 18 within a range of from 3 to 100 mm2, in particular of about 25 mm2, is detectable. The uniform appearance makes it possible to guarantee that a small piece of protective film 22 of about 25 mm2, regardless of its position in the protective film 18, is detectable, unlike in the detection method of the prior art.

By way of indication, the protective film 18 comprises a density of magnetic particles 24 sufficient to guarantee detection of a piece of protective film 18 having an area of about 25 mm2, regardless of its position in the protective film 18. This density may be adjusted according to the required detectability, the characteristics of the magnetic particles 24 and the sensitivity of the sensor used to detect them.

For the present application, the term “a magnetic particle” is intended to mean a particle which exhibits permanent magnetization and generates a permanent magnetic field, such as for example neodymium particles, or a particle configured to become magnetic in the presence of a magnetic field, such as for example a particle of ferromagnetic material.

Each magnetic particle 24 has a size of less than or equal to ten or so micrometers.

According to one embodiment, the protective film 18 is made from a molten material formed into a film According to one feature of the invention, the magnetic particles 24 are introduced into the molten material before it is formed. According to one procedure, the molten material containing the magnetic particles 24 is kneaded until a homogeneous mixture is obtained, in order to obtain a uniform distribution of the magnetic particles 24 over the entire area of the protective film 18.

The detection step comprises moving, above the final positioned layer of fibers 10 of the preform 12, at least one sensor 26 configured to detect at least one magnetic particle 24. The sensor 26 may be a magnetic sensor, an inductive sensor, or the like.

According to a first procedure, the magnetic sensor 26 is moved manually.

According to a second embodiment, the magnetic sensor 26 is moved by means of a robot.

During the detection step, the magnetic sensor(s) is (or are) moved in such a way as to run over the entire area of the final positioned layer of fibers 10 in order to detect a magnetic particle 24 regardless of its position on the layer of fibers 10.

The detection step makes it possible to detect the smallest pieces of protective film 22 as early as possible.

The invention is not limited to the magnetic particles 24. Thus, the protective film 18 may comprise any type of particles 24 exhibiting at least one physical characteristic different from those of the fibers of the layer(s) of fibers 10 and those of the resin when the fibers are pre-impregnated, the physical characteristic being detectable, in a contactless manner, by a suitable sensor 26 configured to be moved above the layer of fibers 10.

The presence of detectable particles 24 allows the detection of small pieces of film even in areas of complex shape. It makes it possible to gain time during the step of verifying the parts.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for manufacturing a part made of composite material, the part made of composite material comprising:
a stack of layers of fibers from fiber plies,
a fiber ply comprising at least one layer of fibers and also at least one protective film covering at least one face of the layer of fibers, and
at least one matrix of at least one material,
the protective film comprising particles, embedded in the matrix of the protective film, having at least one physical characteristic different from those of the fibers of the layer of fibers, said physical characteristic being detectable by at least one suitable sensor and the particles being uniformly distributed over an entire area of the protective film,
the manufacturing method comprising:
laying up layers of fibers from fiber plies,
removing a protective film for each fiber ply, and
polymerizing or consolidating the material,
before the polymerizing or consolidating step, at least one step of detecting the particles of the protective film or piece of the protective film possibly present on at least one laid-up layer of fibers.

2. The method for manufacturing a part made of composite material as claimed in claim 1, wherein the manufacturing method comprises several detection steps during the laying up step, a detection step after each positioning of a layer of fibers.

3. The method for manufacturing a part made of composite material as claimed in claim 1, wherein the several detection steps comprise moving, above a final positioned layer of fibers, at least one sensor configured to detect at least one of the particles.

4. The method for manufacturing a part made of composite material as claimed in claim 3, wherein the sensor is a magnetic sensor or an inductive sensor.

5. The method for manufacturing a part made of composite material as claimed in claim 3, wherein the at least one sensor is moved so as to run over an entire area of the final positioned layer of fibers to detect a particle regardless of its position on the layer of fibers.

6. The method for manufacturing a part made of composite material as claimed in claim 4, wherein the particles are magnetic.

7. The method for manufacturing a part made of composite material as claimed in claim 6, wherein the particles exhibit a permanent magnetization or are configured to become magnetic in a presence of a magnetic field.

8. The method for manufacturing a part made of composite material as claimed in claim 2, wherein the particles have a density such that a piece of protective film having an area of about 25 mm2, regardless of its position in the protective film, is detectable.
